(19) United States
(12) Patent Application Publication
(10) Pub. No.: US 2014/0176689 A1
(43) Pub. Date: Jun. 26, 2014

(54) APPARATUS AND METHOD FOR ASSISTING THE VISUALLY IMPAIRED IN OBJECT RECOGNITION

(71) Applicant: SAMSUNG ELECTRONICS CO., LTD., Suwon-si (KR)

(72) Inventors: Howard Z. Lee, San Jose, CA (US); Muhammad S. KARIM, San Jose, CA (US)

(73) Assignee: SAMSUNG ELECTRONICS CO. LTD., Suwon-si (KR)

(21) Appl. No.: 13/723,728

(22) Filed: Dec. 21, 2012

(51) Int. Cl. G06F 3/0481

(52) U.S. Cl. CPC G06F 3/0481
USPC 348/62; 715/865

(57) ABSTRACT

An apparatus and method for assisting object recognition are provided. The method includes detecting at least one object in an image, determining which of the at least one object is selected by a user, providing feedback to the user so as to enable the user to center the selected object within the image, and capturing an image of the selected object in which the selected object is centered within the image.

### BACKGROUND OF THE INVENTION

1. Field of the Invention

The present invention relates to an apparatus and method for assisting the visually impaired. More particularly, the present invention relates to an apparatus and method for assisting the visually impaired in object recognition.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

Electronic imaging devices, which include cameras included in a mobile device (the image capturing function), is being recognized as a valuable tool for the blind or the visually impaired. These individuals may use a camera incorporated into a mobile device to capture an image of an object that they cannot see clearly due to their impairment. The captured image may be analyzed by object recognition software to identify the object of the user's interest and inform the user of the object's identity.

However, due to the user's visual impairment, it may be difficult for the user to properly frame the desired object within the image. If the object is not framed properly, then the object recognition software may not be able to identify the object correctly. In this case, the user may need to capture several images, and may become frustrated due to the software's inability to properly identify the object or the user's own inability to frame the object in the image. Accordingly, there is a need for a mechanism to assist visually impaired individuals in taking a picture for the purpose of recognizing an object.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for assisting the visually impaired in framing images for the purpose of object recognition.

In accordance with an aspect of the present invention, a method for assisting object recognition is provided. The method includes detecting at least one object in an image, determining which of the at least one object is selected by a user, providing feedback to the user so as to enable the user to center the selected object within the image, and capturing an image of the selected object in which the selected object is centered within the image.

In accordance with another aspect of the present invention, a mobile device is provided. The mobile device includes a camera including a camera sensor for sensing an image, a display unit for displaying the image to the user, a detection unit for detecting objects within the image, a feedback unit for providing feedback to the user so as to enable the user to center the selected object within the image, and a controller for controlling the camera to capture an image when the selected object is centered within the image.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 shows a mobile device according to an exemplary embodiment of the present invention;

FIG. 2 is a flowchart of a method of assisting a user in framing an object according to an exemplary embodiment of the present invention;

FIG. 3 is a flowchart of a method of detecting an object of interest to a user according to an exemplary embodiment of the present invention;

FIG. 4 is a flowchart of a method of detecting an object of interest to a user according to an exemplary embodiment of the present invention; and

FIG. 5 is a flowchart of a method of detecting an object of interest to a user according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for assisting a visually impaired individual in framing an object in an image for object recognition. The apparatus may be embodied in a mobile device having an image capturing unit, including a camera, smart phone, cellular phone, personal digital assistant, personal entertainment device, tablet, laptop computer, or the like.

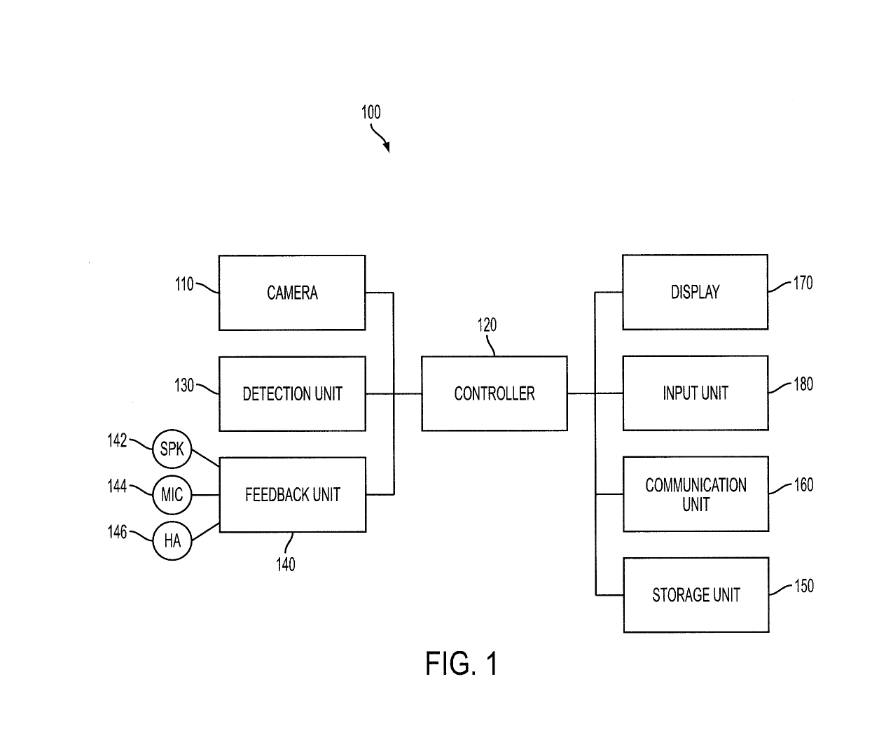

FIG. 1 shows a mobile device according to an exemplary embodiment of the present invention.

Referring to FIG. 1, a mobile device 100 includes a camera 110, a controller 120, a detection unit 130, a feedback unit 140, a storage unit 150, a communication unit 160, a display 170, and an input unit 180. The feedback unit 140 may interact with the user through a speaker 142, a microphone 144, the input unit 180, and optionally a haptic actuator 146 for providing haptic feedback (e.g., vibration. The mobile device may also include additional units not shown here for clarity, such as a Global Positioning System (GPS) unit.

The camera 110 captures an image through a lens. The camera 110 includes a camera sensor (not shown) for converting a captured optical signal into an electrical signal and a signal processor (not shown) for converting an analog video signal received from the camera sensor into digital data. The camera sensor may be a Charge Coupled Device (CCD) sensor or a Complementary Metal-Oxide Semiconductor (CMOS) sensor, and the signal processor may be a Digital Signal Processor (DSP), to which the present invention is not limited.

According to exemplary embodiments of the present invention, the camera 110 captures the image based on audio or other feedback provided to the user. This feedback allows the user to properly frame an object of interest within the picture to be taken. The data from the camera sensor may be provided to the display 170 so that the display 170 may act as a viewfinder. The data may also be provided to the detection unit 130 and the feedback unit 140 for object detection and feedback, respectively.

The controller 120 controls overall operations of the mobile terminal 120. The controller 120 executes an operating system stored in the storage unit 150. To the extent that any of the units of the mobile terminal described above are implemented as software, the controller executes the software code portions and controls the operation of the mobile terminal according to the executed software code. However, while some of the above-mentioned units may be implemented partially or wholly as software, it would be understood that at least one of the above-mentioned units (e.g., the camera 110 or the display 170) would need to be implemented at least partially as hardware in order to carry out their functions.

The detection unit 130 detects objects in the image data provided by the camera 110. The detection unit 130 may use various image processing algorithms to detect objects in the image, and may extract object attributes such as size, shape, color, type, distance from the device, and the like. These object attributes may be used to identify the object(s) in the image. In addition, the detection unit 130 may also detect the user's hand or finger, if they are present in the image. These image processing algorithms may be executed in real time so as to provide feedback to the user, as described below.

In addition, after the user takes a picture of a selected object with the camera 110, the detection unit may perform additional image processing to identify the object so that information about the object may be provided to the user. This additional image processing may be performed by the detection unit 130, or the detection unit 130 may request additional image processing from a remote server (not shown).

The feedback unit 140 determines which object is the object the user is interested in, and provides feedback to the user to ensure that the selected object is centered in the image. The feedback may be audio feedback through the speaker 142 or haptic feedback (such as vibrations) generated by the haptic actuator 146. The feedback unit 140 may also receive input from the user via the input unit 180 or the microphone 144. This input may be used, for example, to determine which of several objects in the image the user is interested in.

If the microphone 144 is used to receive user input, the feedback unit 140 may employ voice recognition to determine what the user is saying. Any voice recognition process may be employed, and the voice recognition function may be integrated into the feedback unit 140 or provided by another component or application of the mobile device.

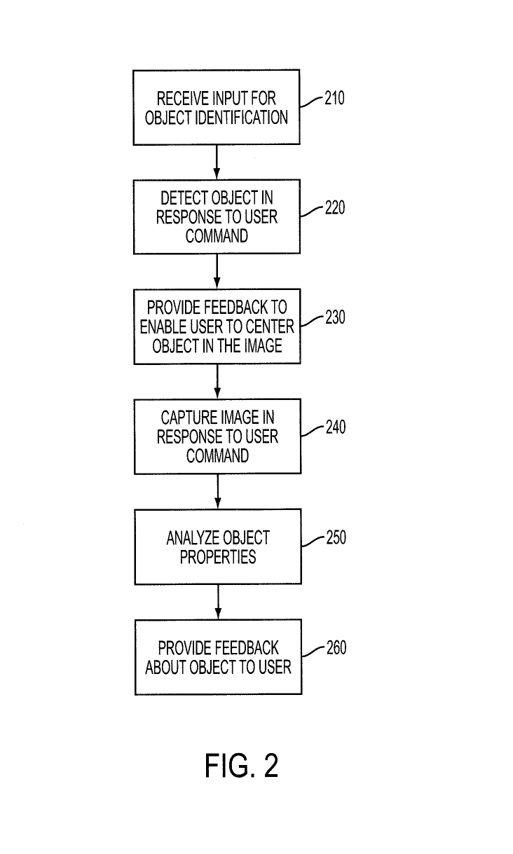

After the user takes the picture using the camera 110, the feedback unit 140 provides the user with information about the selected object. The feedback unit 140 may present the user with this information via the speaker 142. For example, if the selected object is a coffee cup, the feedback unit 140 may inform the user that the selected object is a coffee cup via the speaker 142. The operation of the feedback unit 140 and the detection unit 130 are described below with respect to FIGS. 2-5.

The storage unit 150 stores data and programs used by the mobile device. The storage unit 150 may also store the pictures taken by the user with the camera 110.

The communication unit 160 communicates with other devices and servers. The communication unit 160 may be configured to include a Radio Frequency (RF) transmitter (not shown) for up-converting the frequency of transmitted signals and amplifying the transmitted signals, and an RF receiver (not shown) for low-noise amplifying of received RF signals and down-converting the frequency of the received RF signals. If the detection unit 130 requests image processing from a remote server, the detection unit 130 communicates with the remote server via the communication unit 160.

The display 170 may be provided as a Liquid Crystal Display (LCD). In this case, the display 170 may include a controller for controlling the LCD, a video memory in which image data is stored and an LCD element. If the display 170 is provided as a touch screen, the display 170 may perform a part or all of the functions of the input unit 170. The display 170 may also be provided as an Organic Light Emitting Diode (OLED) display, or as any other type of display.

The input unit 180 may include a plurality of keys to receive user input. For example, the user may enter input via the input unit 180 to select an object, as described below with respect to FIGS. 2-5. The input unit 180 may be configured as a touch screen integrated with the display 170. The number, format, type, and arrangement of the keys of the input unit 180 may vary according to the type, design, or purpose of the mobile device 100.

Various methods for assisting a user in identifying an object are described below with respect to FIGS. 2-5. These methods may be broadly classified into two scenarios. In the first scenario, the user selects the object with his or her hand. For example, the user might point at the selected object with a finger or hold the selected object in his or her hand. In the second scenario, the detection unit 130 detects a plurality of objects in the image and guides the user to select the desired object via the feedback unit 140. Of course, other techniques for guiding the user to select the object could also be employed.

FIG. 2 is a flowchart of a method of assisting a user in framing an object according to an exemplary embodiment of the present invention.

Referring to FIG. 2, the user inputs a command to begin the object identification process in step 210. The user may input the command by voice recognition via the microphone 144, or via the input unit 180.

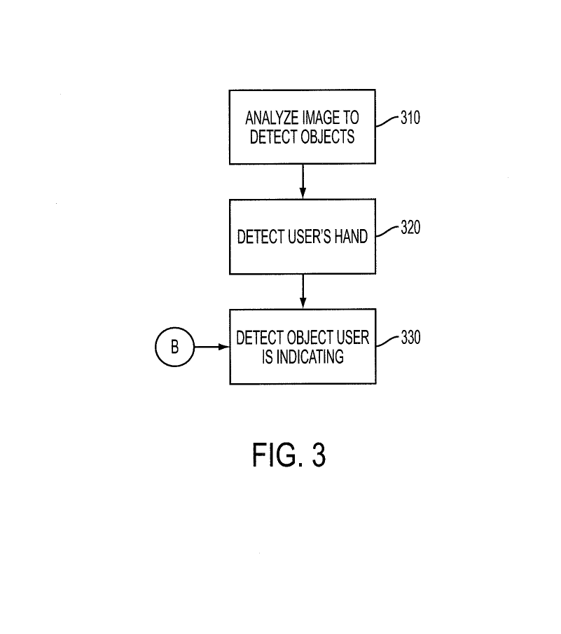

In step 220, the detection unit 130 detects the object selected by the user. The object detection may employ the first scenario, detecting the object indicated by the user's hand, or the second scenario, detecting a plurality of objects and then determining which object is the user's selected object. Examples of this process are described in more detail below with respect to FIGS. 3-5.

In step 230, the feedback unit 140 provides feedback to the user to allow the user to center the selected object in the picture. For example, if the selected object is too far to the right, the feedback unit 140 could tell the user to move the camera to the left. For example, the feedback unit 140 could output “Move the camera to the left” over the speaker 142. Similarly, the feedback unit 140 could control the haptic actuator to vibrate the mobile device 100 on the left side to indicate to the user that the camera should be moved to the left.

Once the selected object has been properly centered, the feedback unit 140 informs the user that a picture of the object may now be taken. As before, the feedback unit 140 could output a message over the speakers, vibrate the phone, or display an icon on the display 180. The user then takes the picture in step 240. In taking the picture, the camera 110 may employ various imaging techniques to improve the appearance of the captured image. For example, once the selected object is sufficiently centered, the camera 110 may perform an automatic focusing technique on the image or may crop the captured image so that only the selected object is present. Some or all of these processing operations may be performed by the detection unit 130.

In step 250, the detection unit 120 receives the image data of the picture from the camera 110 and analyzes the properties of the object. These properties may include color, relative size, shape, type, and the like. The detection unit 120 may use real-time image processing to determine the attributes of the selected object and to identify the selected object. In addition, the detection unit 120 may also request an external server or another external device to perform additional image processing as needed.

In step 260, the feedback unit 140 provides feedback to the user about the selected object. For example, the feedback unit 140 may output a message “You have taken a picture of a coffee cup”. To the extent possible, the feedback unit 140 may also output additional information about the selected object in response to user input. For example, if the user wants to know what color the coffee cup is, or to read a message on the coffee cup, the feedback unit 140 may output information in response to the user's questions. Although the feedback unit 140 may output the feedback as audio, other forms of feedback may also be employed.

FIG. 3 is a flowchart of a method of detecting an object of interest to a user according to an exemplary embodiment of the present invention. FIG. 3 shows a scenario in which the user indicates a selected object using a hand or other body part.

Referring to FIG. 3, the first scenario, as described above, is a scenario in which the user is pointing to a particular object, holding a particular object, or otherwise indicating a particular object using a hand or other body part, such as a finger. The image data received from the camera sensor will therefore include, in addition to one or more objects, the user's hand (or other body part). The method described in FIG. 3 occurs in real-time, as the user points the camera 110 in the direction of the selected object.

In step 310, the detection unit 130 analyzes the image data received from the camera 110 and detects the objects in the image according to an image processing algorithm, which may take into account various features of the objects, including size, shape, distance from the mobile device 100, and color. In step 320, the detection unit 130 determines which of the objects is the user's hand or finger. The detection unit 130 may also differentiate the user's hand or finger from other hands or fingers that may be present in the picture by, for example, determining whether the hand's position in the image is consistent with the hand belonging to the user.

In step 330, the detection unit 130 determines the object which the user is indicating. For example, if the user's hand is determined to be holding a stuffed animal, the detection unit 130 may conclude that the stuffed animal is the selected object. If the detection unit 130 determines that the user's finger is pointing toward a coffee cup, the detection unit 130 may conclude that the coffee cup is the selected object. The detection unit 130 may then provide information about the selected object to the feedback unit 140 for further processing.

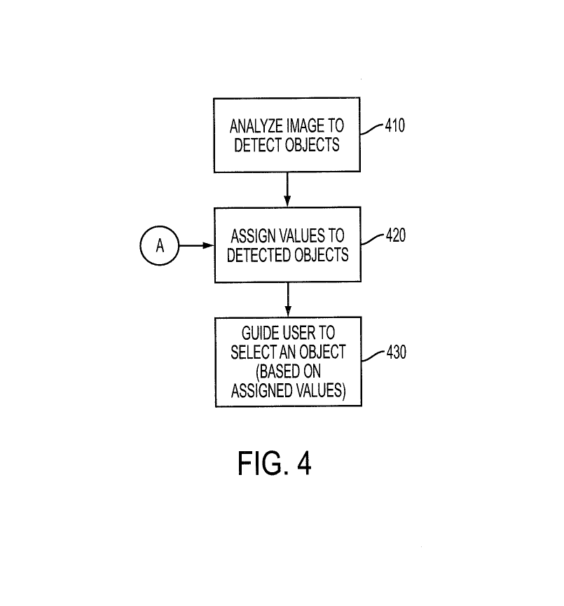

FIG. 4 is a flowchart of a method of detecting an object of interest to a user according to an exemplary embodiment of the present invention. FIG. 4 shows a scenario in which the feedback unit guides the user in selecting one of several objects in the image.

Referring to FIG. 4, the second scenario is a scenario in which the user's hand is not present, and the feedback unit 140 assists the user in selecting one of the objects in the image.

In step 410, the detection unit analyzes the image received from the camera 110 and identifies all of the objects in the image. This image processing is performed in real time, as the user views the image on the display 170. The objects may be differentiated according to size, shape, distance from the mobile device 100, or color. In step 420, the detection unit assigns values, such as letters or numbers, to each of the identified objects.

In step 430, the feedback unit 140 uses the assigned values to guide the user in selecting one of the objects in the image. For example, the feedback unit could output a message over the speakers 142, such as “I have found four objects in the picture. Now I need your help to figure out which object you would like more information about.” The feedback unit 140 may then guide the user through each of the objects until the user indicates the object that is the object of interest.

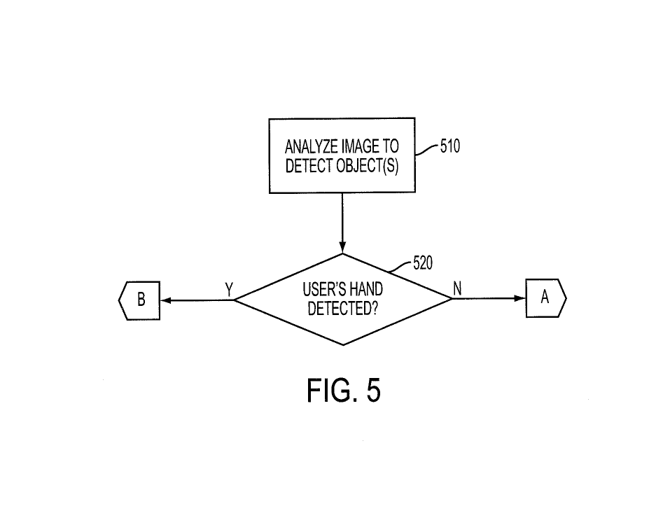

Although the two scenarios have been described above as separate scenarios, the scenarios could be combined, such that the detection unit 130 first determines whether the user's hand is present in the image (the first scenario) before the feedback unit guides the user through selecting an object (the second scenario). This is described below with respect to FIG. 5

FIG. 5 is a flowchart of a method of detecting an object of interest to a user according to an exemplary embodiment of the present invention.

Referring to FIG. 5, the detection unit 130 analyzes the image received from the camera sensor in step 510. In step 520, the detection unit 130 determines whether the user's hand (or other body part) is present in the image. The detection unit 130 may employ any image processing or analysis operation to determine whether the user's hand/finger is present in the image, including distinguishing the user's hand/finger from other body parts that may be present in the image. If the user's hand is not present in the image, the detection unit 130 determines that the second scenario applies and proceeds to step 420 of FIG. 4. If the user's hand is present in the image, the detection unit 130 determines that the first scenario applies and proceeds to step 330 of FIG. 3.

Certain aspects of the present invention can also be embodied as computer readable code on a computer readable recording medium. A computer readable recording medium is any non-transitory data storage device that can store data which can be thereafter read by a computer system. Examples of the computer readable recording medium include Read-Only Memory (ROM), Random-Access Memory (RAM), CD-ROMs, magnetic tapes, floppy disks, and optical data storage devices. Functional programs, code, and code segments for accomplishing the present invention can be easily construed by programmers skilled in the art to which the present invention pertains.

According to exemplary embodiments of the present invention, real-time image processing and feedback enables a mobile device to assist a visually impaired user in identifying and focusing on a particular object of interest. As a result, the user is able to identify objects that the user is unable to see properly.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for assisting object recognition, the method comprising:
detecting at least one object in an image;
determining which of the at least one object is selected by a user;
providing feedback to the user so as to enable the user to center the selected object within the image; and
capturing an image of the selected object in which the selected object is centered within the image.

2. The method of claim 1, further comprising:
determining properties of the selected object in the captured image; and
identifying the selected object based on the determined properties; and
informing the user of the selected object's identity.

3. The method of claim 2, wherein the identifying of the selected object comprises requesting additional object recognition processing from a remote server.

4. The method of claim 1, wherein the determining of which object is the object selected by the user comprises:
detecting a body part of the user within the image;
determining which object is being indicated by the body part of the user within the image; and
determining that the object indicated by the body part of the user is the object selected by the user.

5. The method of claim 4, wherein the body part of the user comprises the user's hand, and
wherein the determining of which object is being indicated by the user's hand comprises determining which object is being held in the user's hand.

6. The method of claim 4, wherein the body part of the user comprises the user's finger, and
wherein the determining of which object is being indicated by the user's finger comprises determining which object is being pointed to by the user's finger.

7. The method of claim 1, wherein the determining of which object is selected by the user comprising:
assigning a unique value to each of a plurality of objects in the image;
presenting the values to the user until the user indicates one of the values; and
determining that the object selected by the user is the object corresponding to the indicated value.

8. The method of claim 1, wherein the determining of which object is selected by the user comprises:
determining whether a body part of the user is present within the frame;
if the body part of the user is not present within the frame, assigning a unique value to each of a plurality of objects in the image, presenting the values to the user until the user indicates one of the values, and determining that the object selected by the user is the object corresponding to the indicated value; and
if the body part of the user is present within the frame, determining which object is being indicated by the body part of the user within the image, and determining that the object indicated by the body part of the user is the object selected by the user.

10. A mobile device, comprising:
a camera including a camera sensor for sensing an image;
a display unit for displaying the image to the user;
a detection unit for detecting objects within the image;
a feedback unit for providing feedback to the user so as to enable the user to center the selected object within the image; and
a controller for controlling the camera to capture an image when the selected object is centered within the image.

11. The mobile device of claim 10, further comprising:
at least one of a speaker and a haptic actuator,
wherein the feedback unit provides feedback to the user via the speaker or the haptic actuator.

12. The mobile device of claim 10, wherein the detection unit determines properties of the selected object in the captured image, and identifies the selected object based on the determined properties, and
wherein the feedback unit provides feedback to the user as to the selected object's identity as determined by the detection unit.

13. The mobile device of claim 12, wherein the detection unit requests additional object recognition processing from an external server so as to identify the selected object.

14. The mobile device of claim 10, wherein the detection unit detects a body part of the user within the image, determines which object is being indicated by the body part of the user within the image, and determines that the object indicated by the body part of the user is the object selected by the user.

15. The mobile device of claim 14, wherein, when the body part of the user comprises the user's hand, the detection unit determines that the object indicated by the user's hand is an object being held in the user's hand.

16. The mobile device of claim 14, wherein, when the body part of the user comprises a finger, the detection unit determines that the object indicated by the user's finger is an object toward which the user's finger is pointing.

17. The mobile device of claim 10, wherein the detection unit detects a plurality of objects within the image, assigns a unique value to each of the plurality of objects, and determines which of the values is indicated by the user, and determines that the object selected by the user is the object corresponding to the value indicated by the user.

18. The mobile device of claim 17, wherein the feedback unit provides feedback to the user so as to enable the user to indicate the value corresponding to the object selected by the user.

19. The mobile device of claim 10, wherein the detection unit determines whether a body part of the user is present within the frame,
wherein, if the detection unit detects the body part of the user within the frame, determines which object is being indicated by the body part of the user within the image, and determines that the object indicated by the body part of the user is the object selected by the user, and
wherein, if the detection unit does not detect the body part of the user within the frame, the detection unit detects a plurality of objects within the image, assigns a unique value to each of the plurality of objects, and determines which of the values is indicated by the user, and determines that the object selected by the user is the object corresponding to the value indicated by the user.

20. The mobile device of claim 10, further comprising:
a microphone for receiving user input.
